(19) United States
(12) Patent Application Publication
(10) Pub. No.: US 2024/0383564 A1
(43) Pub. Date: Nov. 21, 2024

(54) DRIVE DEVICE FOR AN ELECTRIC BICYCLE, COMPRISING AN ELECTRONIC CADENCE CONTROLLER

(71) Applicant: BROSE ANTRIEBSTECHNIK GMBH & CO. KOMMANDITGESELLSCHAFT, BERLIN, Berlin (DE)

(72) Inventors: Mick Jordan, Bochum (DE); Christfried Weigel, Berlin (DE)

(21) Appl. No.: 18/693,895

(22) PCT Filed: Sep. 13, 2022
(86) PCT No.: PCT/EP2022/075344

§ 371 Date: Mar. 20, 2024

(30) Foreign Application Priority Data
Sep. 15, 2021 (DE) 10 2021 210 230.1

(51) Int. Cl. B62M 6/50; B62M 6/55

(52) U.S. Cl. CPC B62M 6/50; B62M 6/55

(57) ABSTRACT

It is provided a drive device for an electric bicycle, comprising a bottom bracket shaft for driving a wheel of the electric bicycle by muscle power, an electric motor for providing an additional driving torque for driving the wheel, and an electronic control unit for controlling the electric motor. Via the control unit a nominal cadence can be specified for the bottom bracket shaft by a user of the electric bicycle by selecting one of at least two different predefined assistance levels, from which a maximum driving power is provided by the electric motor.

### BACKGROUND

The proposed solution in particular relates to a drive device for an electric bicycle.

It is known to employ two electric motors in combination with a superposition transmission on an electric bicycle, hence on a so-called E-Bike or Pedelec, in order to steplessly adjust a gear ratio between input and output. Such a drive device on the one hand includes a bottom bracket shaft via which a driving torque generated by a rider of the electric bicycle can be introduced and on which pedals are provided therefor. Via an output shaft of the drive device to be coupled with a wheel of the electric bicycle a driving torque introduced on the bottom bracket shaft and/or an electromotively generated torque then is transmitted to a wheel, usually a rear wheel of the electric bicycle. Via the superposition transmission the bottom bracket shaft and the output shaft are coupled with each other, wherein a torque generated by a first electric motor of the two electric motors can at least partly be transmitted to the output shaft. Via the second electric motor of the two electric motors a gear ratio is steplessly adjustable so that the electric bicycle can be accelerated via a driving torque of the first electric motor without the bottom bracket shaft having to be rotated more quickly or with greater force. In this way, the second electric motor also serves to support the torque introduced by the rider and therefor can rotate a rotor shaft in different directions of rotation depending on the gear ratio. A drive device for an electric bicycle with a comparable superposition transmission and two electric motors is known for example from EP 2 218 634 B1.

In addition, however, there are also known drive devices for electric bicycles with exactly one electric motor. In this case, an assistance power in principle is proportional to a rider torque introduced on a bottom bracket shaft of the electric bicycle by muscle power. Hence, it then is not possible for a user to vary the assistance power of the electric motor and hence for example select the assistance power step by step.

### SUMMARY

Against this background it is the object underlying the concrete solution to provide a drive device improved in this respect, in particular an improved drive device with exactly one electric motor.

This object is achieved with a drive device having features as described herein.

Accordingly, it is provided that the drive device can select one of at least two different predefined assistance levels via an electronic control unit by a user of the electric bicycle, and a nominal cadence thereby is specified for the bottom bracket shaft, from which a maximum driving torque is provided by the electric motor.

Thus, a basic idea of the proposed solution consists in offering widely used assistance levels known to a user or rider of the electric bicycle from practice, such as for example “Eco”, “Tour”, “Sport” and/or “Boost”/“Turbo”. However, no defined assistance power then is stored for each of these assistance levels, hence no previously defined additional driving torque with which a rider torque introduced by muscle power is supported to a different extent depending on the assistance level. Rather, via the selection of an assistance level a nominal cadence (nominal pedaling frequency) here is specified for the bottom bracket shaft, from which a maximum driving power is provided on the part of the electric motor. Thus, depending on the assistance level a user must pedal faster in order to be provided with the maximum driving power on the part of the electric motor. Thus, it is possible in particular to provide a drive device with different assistance levels for a user despite an assistance power proportional to the introduced rider torque.

For example, it is provided that in a first assistance level of the at least two different predefined assistance levels a larger nominal cadence is specified than in a second assistance level. In the first assistance level, a smaller rider torque to be introduced by muscle power and applied to the electric motor hence in principle is provided than in the second assistance level. For example, a cadence of 80 revolutions per minute is set in the first assistance level, while a cadence of 60 revolutions per minute is set in the second assistance level. The first assistance level then for example is designated with “Eco”, while the second assistance level is designated with “Boost”.

In one embodiment, at least two different cadence ranges furthermore can be selected via the control unit, within which nominal cadences must lie for the at least two different assistance levels. This for example includes the possibility that depending on the type of rider and/or bicycle different cadence ranges are predefined and selectable via the control unit, for example also merely on the part of the manufacturer, in order to be able to use the same drive device depending on the type of bicycle, but then variably configure the same via different cadence ranges.

For example, a first cadence range with 30 to 60 revolutions per minute and a second cadence range with 60 to 90 revolutions per minute can be selected via the control unit. In a possible development, a third cadence range with 50 to 80 revolutions per minute can also be selectable in addition. The up to three different cadence ranges for example are provided for three different types of rider or three different types of bicycle. For example, the aforementioned cadence ranges can then be representative of city riders (30 to 60 revolutions per minute), trekking riders (50) to 80 revolutions per minute) or amateur athletes (60) to 90 revolutions per minute).

In principle, identical assistance levels always can be selectable by a user of the electric bicycle via the control unit independently of a selected cadence range, wherein the same assistance levels specify different nominal cadences depending on the cadence range. In other words, one of possibly several different cadence ranges possibly is selected or configured. With regard to their designations indicated for the user, however, the selectable assistance levels always remain identical. In terms of hardware and/or software, another nominal cadence then is linked with each assistance level depending on the cadence range. For a first assistance level (for example “Eco”), the nominal cadence can be about 60 revolutions per minute, 80 revolutions per minute or 90 revolutions per minute, depending on which cadence range and hence possibly which type of rider/bicycle is configured.

In principle a drive device of the proposed solution can be equipped with one electric motor, in which the driving torque additionally provided by the electric motor is proportional to a rider torque introduced by muscle power via the bottom bracket shaft. In particular, the drive device accordingly can include exactly one electric motor, in which a corresponding proportional dependency is present in principle.

The electronic control unit can comprise an indicating element for displaying a currently set assistance level. The indicating element can be formed for example by a display via which an indicator for the currently set assistance level is displayed. A corresponding indicating element also can include an operating part for switching between the predefined assistance levels. For a rider-specific or bicycle type-specific definition of different cadence ranges a corresponding operating element is not absolutely necessary. The same can also be implemented purely in terms of software. The nominal cadence consequently can be associated automatically by drive or system software.

The subject-matter of the proposed solution furthermore also is an electric bicycle comprising an embodiment of a proposed drive device.

In addition, there is proposed a method for controlling a drive of an electric bicycle, in which switching between at least two different predefined assistance levels is effected for a user of the electric bicycle, in order to specify different nominal cadences for a bottom bracket shaft, from which a maximum driving torque is provided by an electric motor of the electric bicycle.

### BRIEF DESCRIPTION OF THE DRAWINGS

The attached Figures by way of example illustrate possible embodiments of the proposed solution.

FIG. 1 shows an electric bicycle comprising an embodiment of a proposed drive device.

FIG. 2 shows a handlebar of the electric bicycle of FIG. 1 in an enlarged view with a representation of a display of a control unit of the drive device.

### DETAILED DESCRIPTION

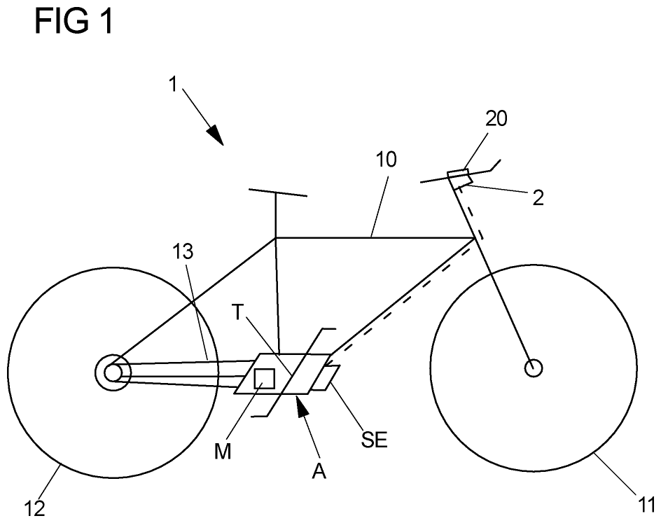

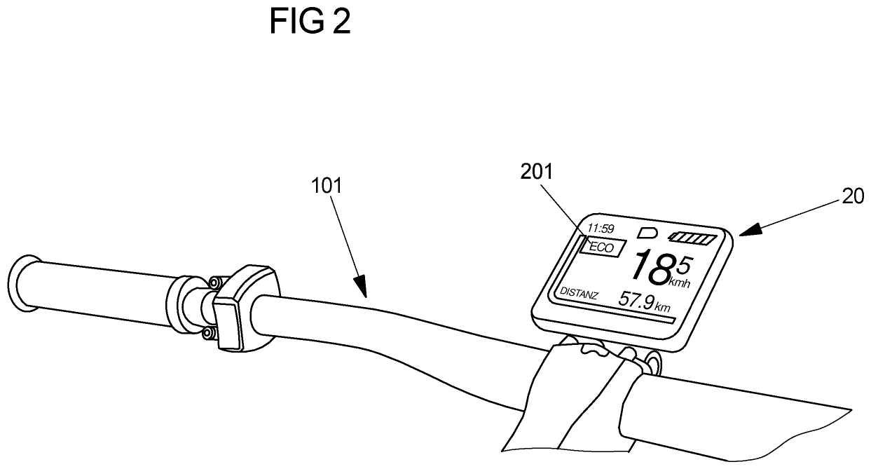

FIG. 1 shows a side view of an electric bicycle 1 with an embodiment of a proposed drive device A. The electric bicycle 1 comprises a frame 10 on which a front wheel 11 and a rear wheel 12 are rotatably mounted. The rear wheel 12 is coupled with the drive device A via a power transmission element in the form of a chain or a belt 13. The drive device A includes a rotatably mounted bottom bracket shaft T with pedals for introducing a rider torque by means of muscle power. In addition, exactly one electric motor M is provided in the drive device A, which provides an additional driving torque for driving the rear wheel 12. The drive device A furthermore includes an electronic control unit SE which is coupled with a control unit 2. In the present case, this control unit 2 is provided in the region of a handlebar 101 of the electric bicycle 1. This handlebar 101 here is shown in FIG. 2 in an enlarged view.

The control unit 2 includes an indicating element in the form of a display 20. On this display 20 an operating part is provided for switching an assistance level, for example in the form of a switch. When the drive device A is activated, a mode indicator 201 can be indicated on the display 20, which indicates to a user of the electric bicycle 1 what assistance level currently is chosen. Possible assistance levels here include for example “Eco”, “Tour”, “Sport” and “Boost”.

In the proposed embodiments, an assistance power is proportional to the rider torque introduced at the bottom bracket shaft T via the exactly one electric motor M of the drive device A. Via the different assistance levels, a nominal cadence then however is specified for the bottom bracket shaft T, from which a maximum driving torque is provided by the electric motor M. Thus, assistance levels commonly known from the electric bicycle sector are offered to a rider of the electric bicycle 1 in the display 20. A nominal cadence is associated to each of these assistance levels via the control unit 2. For instance, in the assistance level “Eco” a higher nominal cadence of for example 80 revolutions per minute is specified, while in the assistance level “Boost” a nominal cadence of for example 60 revolutions per minute is specified. The link provided here between assistance level and nominal cadence then reduces or increases the rider torque at the electric motor M. In this way it is possible for example to offer the rider of the electric bicycle 1 familiar assistance levels despite the proportionality between the assistance power and the introduced rider torque.

In addition, the control unit 2 can be configurable on the part of the manufacturer and/or on the part of the user for different rider types and/or types of electric bicycles 1, namely in such a way that different cadence ranges can be selected, which then make the nominal cadences vary, which are linked for the individual assistance levels. For instance, a first cadence range can be selected for a city rider with 30 to 60 revolutions per minute, a second cadence range for a trekking rider with 50 to 80 revolutions per minute, and a third cadence range for an amateur athlete with 60 to 90 revolutions per minute. Depending on the selected cadence range, a different nominal cadence is behind the selectable assistance levels.

The proposed configurability can of course also be provided in a drive device with two electric motors. In such a drive device, the proposed solution also involves an increased operating comfort for a user of the electric bicycle 1.

### LIST OF REFERENCE NUMERALS

1 electric bicycle
10 frame
101 handlebar
11 front wheel
12 rear wheel
13 chain/belt (power transmission element)
2 control unit
20 display (indicating element)
201 mode indicator
A drive device
M electric motor
SE electronic control unit
T bottom bracket shaft

1. A drive device for an electric bicycle, comprising
a bottom bracket shaft for driving a wheel of the electric bicycle by muscle power,
an electric motor for providing an additional driving torque for driving the wheel, and
an electronic control unit for controlling the electric motor,
wherein via the electronic control unit, a nominal cadence, from which a maximum driving power is provided by the electric motor, can be specified for the bottom bracket shaft by a user of the electric bicycle by selecting one of at least two different predefined assistance levels.

2. The drive device according to claim 1, wherein in a first assistance level of the at least two different predefined assistance levels a larger nominal cadence is specified than in a second assistance level.

3. The drive device according to claim 2, wherein a nominal cadence of 80 revolutions per minute is set in the first assistance level, while a nominal cadence of 60 revolutions per minute is set in the second assistance level.

4. The drive device according to claim 1, wherein via the electronic control unit at least two different cadence ranges can be selected, within which nominal cadences for the at least two different predefined assistance levels must lie.

5. The drive device according to claim 4, wherein a first cadence range of 30 to 60 revolutions per minute and a second cadence range of 60 to 90 revolutions per minute can be selected via the electronic control unit.

6. The drive device according to claim 5, wherein a third cadence range of 50 to 80 revolutions per minute additionally can be selected via the control unit.

7. The drive device according to claim 4, wherein identical assistance levels can be selected, via the electronic control unit, by the user of the electric bicycle independently of a selected cadence range, but wherein the assistance levels specify different nominal cadences depending on the cadence range.

8. The drive device according to claim 1, wherein the driving torque additionally provided by the electric motor is proportional to a rider torque introduced by muscle power via the bottom bracket shaft.

9. The drive device according to claim 1, wherein the drive device includes exactly one electric motor (M).

10. The drive device according to claim 1, wherein the electronic control unit comprises an indicating element for displaying a currently set assistance level.

11. An electric bicycle with a drive device according to claim 1.

12. A method for controlling a drive of an electric bicycle, in which a wheel of the electric bicycle can be driven by muscle power via a bottom bracket shaft and an additional driving torque for driving the wheel can be provided by an electric motor of the electric bicycle,
wherein a user of the electric bicycle switches between at least two different predefined assistance levels in order to specify different nominal cadences for the bottom bracket shaft, from which a maximum driving torque is provided by the electric motor.
